(19) United States
(12) Patent Application Publication
(10) Pub. No.: US 2021/0133891 A1
(43) Pub. Date: May 6, 2021

(54) ROOF CONDITION EVALUATION AND RISK SCORING SYSTEM AND METHOD

(71) Applicant: Marshall & Swift/Boeckh, LLC, Irvine, CA (US)

(72) Inventor: Janakiraman Jagannathan, Pewaukee, WI (US)

(21) Appl. No.: 17/127,150

(22) Filed: Dec. 18, 2020

Related U.S. Application Data
(63) Continuation of application No. 14/688,254, filed on Apr. 16, 2015, now abandoned.
(60) Provisional application No. 61/981,623, filed on Apr. 18, 2014.

(51) Int. Cl. G06Q 40/08

(52) U.S. Cl. CPC G06Q 40/08

(57) ABSTRACT

Computer systems and methods for determining a risk indicator for the condition of a roofing system of a building are disclosed. The system may include an interface configured to receive at least one input regarding the building, roofing system, location of the building roofing system, location-specific weather data, historical building performance data, or data extracted from imagery. The system includes a roof condition risk scoring engine configured to receive the input through the interface and to apply the input using a probabilistic roof model to calculate an indicator for a probability of loss associated with the roofing system replacement or reconstruction cost. The probability can be scaled into a roof condition risk score (e.g., a numeric score, a grade, a quality rating, etc.).

### CROSS-REFERENCE TO RELATED APPLICATIONS

The present application is a continuation of U.S. patent application Ser. No. 14/688,254, entitled “ROOF CONDITION EVALUATION AND RISK SCORING SYSTEM AND METHOD” and filed on Apr. 16, 2015, which claims the benefit of U.S. Provisional Patent Application No. 61/981,623, entitled “ROOF CONDITION EVALUATION AND RISK SCORING SYSTEM AND METHOD,” filed Apr. 18, 2014, the disclosures of which are hereby incorporated by reference herein in their entireties.

### TECHNICAL FIELD

The present disclosure generally relates to roof condition evaluation and risk scoring, and more specifically, to systems and methods that can evaluate building roof conditions to determine information useful in property insurance underwriting and pricing, as well as insurance portfolio assessment.

### BACKGROUND

Roofs may get damaged due to various factors (e.g., hail events, other weather conditions, service life, etc.), which may motivate building owners to obtain insurance to cover potential roof damage through property insurance carriers. Building owners may later make an insurance claim in the event that the roof fails or otherwise requires replacement and/or reconstruction. In 2012, the United States experienced 22,500 severe thunderstorm events that impacted roofs and created total insured losses that exceeded $15 billion, while insured losses from thunderstorm wind and hail losses exceeded $25 billion in 2011. Hail-related damage claims jumped 84 percent (from approximately 467,000 to 861,000 claims) between 2010 and 2012. Accordingly, building roof losses are a consideration for insurance underwriting companies, as the magnitude of roof-related losses has the potential to significantly impact a carrier's financial performance.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment.

According to one embodiment, a system is configured to determine an indicator of condition risk of a roof of a real estate property, for example, a building. The system may include an interface configured to receive at least one input regarding the building, roofing system, location of the building roofing system, location-specific weather data, historical building performance data, or data extracted from imagery. The system includes a roof condition risk scoring engine configured to receive the input through the interface. The roof condition risk scoring engine is programmed to apply the input to a model and transform the input into an indicator indicating a probability of loss associated with the roofing system replacement or reconstruction cost. The probability can be scaled into a roof condition risk score (e.g., a numeric score, a grade, a quality rating, etc.).

According to another embodiment, a system is configured to determine an indicator of probability or risk of at least one of a roof of a building needing to be repaired, a roof of a building needing to be replaced, and an insurance claim being made by a holder of an insurance policy insuring the roof of a building. The system may include an interface configured to receive at least an input regarding a building or the location of the building, and additional information regarding the building. The system includes a roof condition risk scoring engine configured to receive the input received through the interface. The roof condition risk scoring engine is programmed to transform the input based on the additional information regarding the building and based on a model into an indicator indicating the probability or risk that the roof of the building will require repair or replacement during a time period, or that a holder of an insurance policy insuring the roof of the building will make a claim on the policy.

In various embodiments, the model of the system is a logistic regression model, a Generalized Linear Model, a Support Vector Machine, a Naïve Bayes model, a Random Forest, or other statistical algorithm or machine learning algorithm. In one embodiment, the model is based on information regarding a plurality of buildings.

According to another embodiment, a roof condition risk scoring engine includes an interface configured to receive an input regarding a building from a first source. The roof condition risk scoring engine is configured to establish a communication link with a second source to obtain information regarding the building from a second source based on the information provided by the first source. The roof condition risk scoring engine is configured to output an indicator indicating the determined condition of roof risk. In one embodiment, the output includes color coding representative of the determined risk.

In one embodiment, the information obtained from the second source includes at least one of the shape of the roof of the building, the age of the roof of the building, whether historical insurance claims that have been filed related to the building, historical insurance claims that have been filed related to the building, the roof covering material type for the building, the slope of the roof of the building, the pitch of the roof of the building, the average snowfall for the location of the building, the average ice for the location of the building, the average rainfall for the location of the building, the average humidity for the location of the building, heat index information for the location of the building, the average cloud cover for the location of the building, temperature information for the location of the building, vegetation level information for the location of the building, elevation information for the location of the building, information regarding historical hail events during a time period, e.g., historical time period, for the location of the building, information regarding historical wind events during a time period, e.g., historical time period, for the location of the building, and information regarding other historic weather events during a time period for the location of the building.

In another embodiment, a system is provided that includes physical data storage configured to store data associated with roofing systems associated with a plurality of real estate properties, and a computer system comprising computer hardware, the computer system in communication with the physical data storage. The computer system is programmed to receive identification information associated with a property, the identification information comprising a location of the property; receive a roofing characteristic associated with a roofing system associated with the property, the roofing system comprising a roof of a building on the property; receive a weather characteristic associated with the location of the property; and generate a roof condition score based at least in part on applying a roof condition model to the roofing characteristic and the weather characteristic.

In another embodiment, a method is provided that includes receiving identification information associated with a property, the identification information comprising a location of the property; receiving a roofing characteristic associated with a roofing system associated with the property, the roofing system comprising a roof of a building on the property; receiving a weather characteristic associated with the location of the property; and applying a roof condition model to the roofing characteristic and the weather characteristic to generate a roof condition score. The method is performed under control of a roof condition risk scoring engine comprising physical computing hardware:

Other objects and advantages associated with the aspects and embodiments disclosed herein will be apparent based on the accompanying drawings and the following detailed description.

### BRIEF DESCRIPTION OF THE DRAWINGS

FIG. 1 is a block diagram illustrating an example of a system configured to provide a roof condition risk indicator;

FIG. 2 is a flow diagram illustrating operation of an example of a method for generating a roof condition risk indicator or estimating a propensity of roof replacement and/or roof reconstruction cost;

FIG. 3 is a block diagram illustrating operation of an example of a system configured to provide an indicator of propensity of loss associated with roof replacement and/or roof reconstruction cost of a building;

FIG. 4 is a table illustrating examples of roof condition risk scores and corresponding probabilities of loss tied to roofing system replacement/reconstruction cost associated with risk scores; and

FIG. 5 is a block diagram illustrating operation of an example of a building valuation platform including a roof condition risk scoring engine that can generate a roof risk score associated with a modeled roof condition.

The accompanying drawings are presented for illustration and not limitation of the following detailed disclosure. Wherever possible, and unless the context indicates otherwise, like reference numerals are re-used to indicate like or similar features in the figures.

### DETAILED DESCRIPTION

### Overview

The substantial gap in the availability and quality of roof data along the insurance value chain is threatening. Insurance carriers have little or no information on roof condition when underwriting a policy. Further, conducting a roof inspection on all risks that are underwritten is not possible or practical. This lack of information on roof condition and the questionable accuracy of policyholder-submitted roof information have prevented carriers from achieving the full potential of pricing segmentation that sophisticated rating plans were intended to generate. The lack of good information on roof condition at the point of underwriting has created adverse selection issues even for carriers that follow disciplined risk selection techniques. The gap between the average $900 annual homeowners premium versus the average $9000 claim payout on a roof loss suggests that insurance providers would benefit from systems and methods that evaluate roof conditions and generate a roof condition risk score indicative of the risk of roof damage.

Although aerial and satellite imagery have improved in recent years, the image resolution currently achieved through such imagery tends to be insufficient with respect to making underwriting decisions regarding roof condition. Further, even if better imagery were available in the future, alternative roof condition evaluation and risk scoring solutions would be beneficial to the insurance industry

Many parties potentially have interest in evaluating building characteristics and/or accurately accessing risks associated with condition of a building's roof, including, e.g., building owners, agents, brokers, risk managers, insurers, reinsurers, investors, etc. Referring generally to the figures, in some embodiments, a system is provided for evaluating current conditions of roofs of buildings (e.g., commercial, residential, etc.) and outputting an indicator indicating the probability of loss associated with the roofing system replacement or reconstruction cost.

Buildings can include, e.g., houses, apartments, condominiums, townhouses, hotels, motels, office buildings, stores, malls, warehouses, factories, restaurants, schools, classrooms, museums, theaters, libraries, hospitals, hangars, churches, and so forth.

Roofing systems (sometimes simply referred to as a “roof”) can include a roof of the building as well as support structures used to support the roof. Roofing systems can include, for example, a roof deck (e.g., a structural substrate), an underlayment (e.g., “felt”), and a roof covering (e.g., external watershedding material such as shingles). Roofing systems can include weatherproofing layers (e.g., leak barriers), reinforcement to add structural stability, and surfacing to protect the weatherproofing and reinforcement. Roofing systems may also include flashing, sheathing, decking, gutters and downspouts, chimneys, ventilation, insulation, skylights, fire barriers, solar energy systems, and so forth. Roofing systems include low slope roofs and steep slope roofs.

In some embodiments, the system creates a roof condition model and applies characteristics of a property, e.g., a building, to the model to generate a score for the roof of the property. The system uses information from a population of properties to create the roof condition model. This population of properties may be related to the building to be evaluated, e.g., being in the same geographic area with the building.

In some embodiments, the population of properties may include buildings. In these embodiments, the information that is used to create the roof condition model may include, for example, location of the buildings (e.g., street address, etc.), building elevation, occupant maintenance behavior, occupant, owner, or consumer financial and location-level demographics data, historical weather information for location of the buildings (e.g., hail, hail size, hail duration, hail direction (e.g., sideways, etc.), date of last hail event, date of last severe hail event, number of hail events, wind, lightning, storms, tornadoes, heat index, snowfall, humidity, frequency of weather events, etc.), ages of the buildings, ages of roofs (e.g., years since roofs were replaced or repaired), building code compliance, builder information, maintenance events, vegetation, roof slopes, roof pitch, roof directions, roof shapes (e.g., whether roof is gabled, etc.), types of roof, roof covering material types (e.g., steel, tin, tile, clay, slate, built-up tar and gravel, architectural shingles, wood shakes, asphalt shingles, etc.), roof dimensions (e.g., measured from imagery), images of roof, whether any insurance claims were made on the roofs, and cost of the claims (e.g., replacement cost of roof, repair cost of roof, etc.). Other information and/or other combinations of information may be used.

A processor can be used to evaluate the information to create a model. In one embodiment, the information is processed and/or analyzed by a generalized linear model with a binomial distribution link function to produce a model. In one embodiment, the model is a generalized linear model. In one embodiment, the model is a binomial distribution. In another embodiment, the information is processed and/or analyzed using logistical regression model. In another embodiment, the information is processed and/or analyzed by a support vector machine to produce a model. In another embodiment, the information is processed and/or analyzed by naïve Bayes analysis to produce a model. In another embodiment, the information is processed and/or analyzed by random forest analysis or decision trees to produce a model. In other embodiments, other statistical or machine learning techniques can be used including, e.g., supervised or unsupervised learning, decision trees, neural networks, Bayesian networks, genetic algorithms, and so forth. In another embodiment, a combination of the foregoing analyses and or processes is used to create a model. In another embodiment, other suitable analysis and/or processing methods and/or mechanisms or combinations of analysis and/or processing methods and/or mechanisms may be used to create a model.

The roof condition model may then be used to evaluate the roof condition of a specific building. Similar information, or characteristics, used in creating the model can be used to evaluate a roof condition of the building. This information includes, for example, location of the building (e.g., street address, etc.), building elevation, occupant maintenance behavior, consumer financial and location-level demographics data, historical weather information for location of the building (e.g., hail, hail size, hail duration, hail direction (e.g., sideway, etc.), wind, lightning, storms, tornadoes, heat index, snowfall, humidity, frequency, etc.), age of the building, age of roof (e.g., years since roof was replaced), building code compliance, builder information, maintenance events, vegetation, roof slope, roof pitch, roof direction, roof shape (e.g., whether roof is gabled, etc.), type of roof, roof covering material type (e.g., steel, tin, tile, clay, slate, built-up tar and gravel, architectural shingles, wood shakes, asphalt shingles, etc.), roof dimension, image of roof, whether any insurance claims were made on the roofs, and cost of the claims (e.g., replacement cost of roof, repair cost of roof, etc.). Other information and/or other combinations of information may be used.

For example, hail can severely damage a roof. The intensity of loss (e.g., damage potential) tends to be exponentially related to the size of the hail stone. Hail stones with diameters greater than about 0.75 inch are considered severe. The roof condition risk of loss will rise with increasing hail size for a particular building. However, frequency of hail storms can also play a role in the roof model. For example, several small storms can cause aggregate damage that might go undetected compared to a single large hail storm (e.g., a property owner is less likely to detect and repair damage caused by multiple small hail storms compared to damage caused by large hail storms). The roof model can take into account information such as, e.g., hail size, hail storm frequency, and the other data described herein to produce a likelihood of loss for a particular building roof.

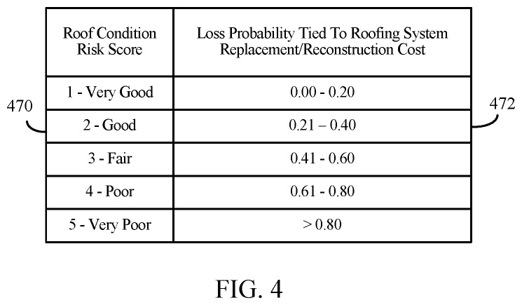

For a building, e.g., an insured building, a potentially insured building, etc., in one embodiment, the model is configured, based on inputs regarding the building, to produce an indicator of roof condition risk, e.g., a roof condition risk score. The roof condition risk score may be indicative of a probability of loss tied to roof replacement or reconstruction cost. The roof condition risk score can be normalized to be in range such as, e.g., 0 to 1, or 1 to 100. The roof condition risk score can be a grade (e.g., A, B, C, D, F) or a quality rating (e.g., from “very poor” to “very good”). For example, as will be discussed with regard to FIG. 4 below, in one embodiment if a probability of loss tied to roof replacement cost/reconstruction cost is in a range from 0.21 to 0.40, the roof condition risk score is good.

In one embodiment, the indicator produced by the model may indicate a probability of loss tied to roof replacement cost/reconstruction cost or a new adjusted replacement/reconstruction cost of the roof, e.g., the probability that the roof of the building will need to be repaired and/or replaced and the potential repair and/or replacement cost, e.g., prediction of cost, of repairing or replacing the roof.

### Example Systems and Methods for Roof Indicators or Roof Conditions

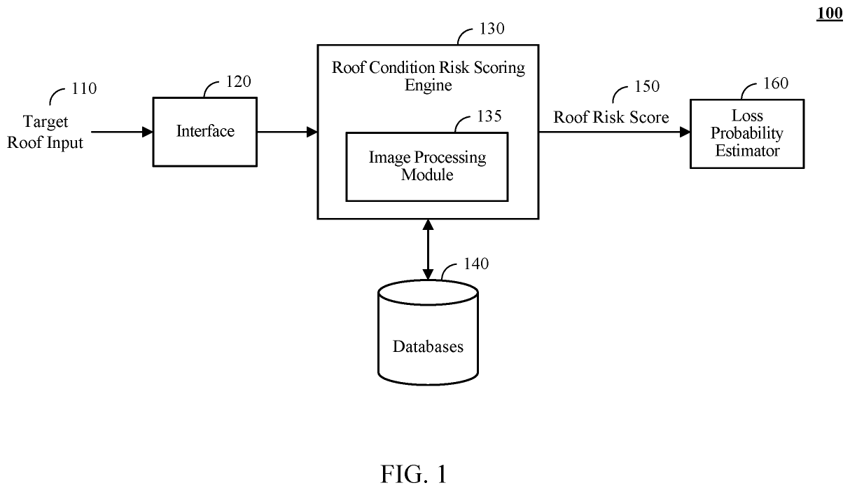

With reference to FIG. 1, a block diagram schematically illustrates an example system 100 configured to provide a roof risk indicator. A roof condition risk scoring engine 130 is configured to analyze a target roof input 110 using a roof model, such as the models discussed herein, to output an indicator, illustrated in this example as a roof condition risk score 150. The roof risk score 150 (and/or data from the databases 140) can be used, at least in part, by a loss probability estimator module 160 to calculate a loss propensity associated with an estimated cost for replacement and/or reconstruction for the roof. The system 100 also includes an interface 120, e.g., a web interface, a web portal, a secure connection, internet interface, etc., through which the target roof input 110 provided by a user can be received by the roof condition risk scoring engine 130. The interface 120 can provide an Application Program Interface (API) that provides protocols, routines, or tools for electronically interacting with the risk scoring engine. The target roof input 110 can be received over a wired or wireless network communication channel. In some embodiments, the roof condition risk scoring engine 130 is implemented on one or more physical computing servers programmed with particular and specific computer instructions to implement the methods described herein.

In one embodiment, the target roof input 110 may be provided by a user such as, for example, an insurer, an underwriter, etc. The target roof input 110 may include information regarding a building that is currently insured, for which insurance is sought, etc. The target roof input 110 may include, for example, building location (e.g., street address, etc.), roof age (e.g., a roof age received from, for example, a building owner seeking insurance for a building, etc.), roof covering material (e.g., information regarding the type of roof covering received from, for example, a building owner seeking insurance for a building, etc.), roof slope (e.g., information regarding the slope of the roof received from, for example, a building owner seeking insurance for a building, etc.), roof pitch (e.g., information regarding the pitch of the roof (e.g., vertical rise divvied by horizontal span or run) received from, for example, a building owner seeking insurance for a building, etc.), roof direction (e.g., information regarding the direction of the roof received from, for example, a building owner seeking insurance for a building, etc.), and roof shape (e.g., information regarding the shape of the roof received from, for example, a building owner seeking insurance for a building, etc.). In other embodiments, other suitable information or combinations of information may be input.

In one embodiment, the target roof input 110 may be provided via the interface 120 for each individual building to be analyzed by a user into the interface (e.g., through a web browser, etc.). In other embodiments, a user may provide a file containing inputs for multiple buildings to the roof condition risk scoring engine 130 through the interface 120 and the roof condition risk scoring engine 130 may process and/or analyze each of the inputs for each of the buildings to produce roof condition risk scores for each of the buildings without further user intervention. In one embodiment, the roof condition risk scoring engine 130 may output the roof risk score 150 to a user through the interface 120. In one embodiment, the roof condition risk scoring engine 130 is configured to connect to, interface with, and/or access one or more databases 140 that store roofing system data, weather and location information data, and building data (see, e.g., databases 352, 354, and 358). The databases 140 can be stored in non-transitory data storage.

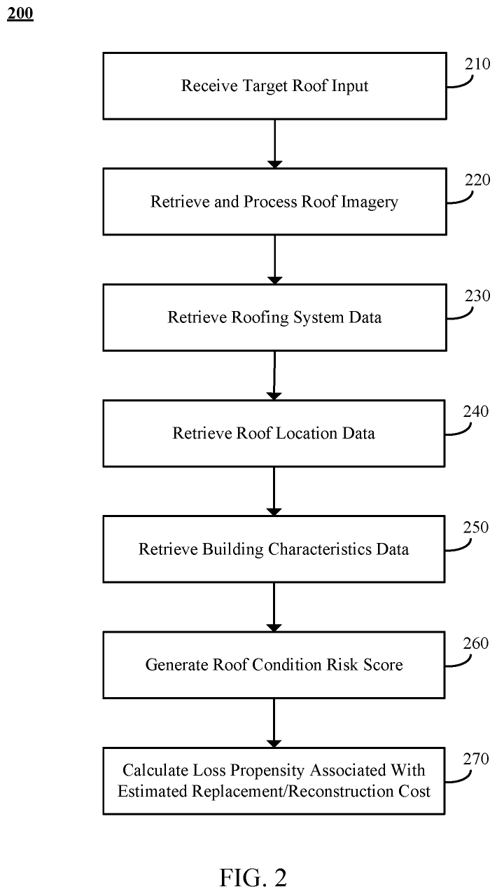

With reference to FIG. 2, a flow diagram illustrates an example method 200 for providing a roof condition risk indicator. The method 200 can be performed by the roof condition risk engine 130 of the system 100. At block 210, the method receives a target roof input from a user, for example, input regarding a building, e.g., location information such as a street address, roofing information such as roof age, etc. The roof input can be received via a network communication channel.

At optional block 220, based on the target roof input received at block 210, the method 200 (optionally) can retrieve an image of the roof of the building, for example, from a third party image provider. The image may be retrieved from various suitable sources, databases, or third parties, etc., for example, Pictometry International Corp. (Henrietta, N.Y.) Google (Mountain View, Calif.), or Microsoft (Redmond, Wash.), based on the input received regarding the building. The image can be a geo-referenced, oblique aerial image of the roof. As used herein, image is a broad term and is used in its general sense and can include, for example, a still image, a video, or a still image from a video. The image can be in a wavelength band such as, e.g., visible, infrared (e.g., thermal), ultraviolet, etc. Also, an image need not refer only to a single image but rather one or more images of the roof can be retrieved and analyzed.

The method 200 then (optionally) processes the image of the roof at block 220. For example, the roof condition risk scoring engine 130 (see FIG. 1) can include an image processing module 135 that can analyze the image of the roof to determine, e.g., whether any shingles are missing from the roof. Based on this analysis, the image processing module 135 may output an indicator to be used by the roof condition risk scoring engine 130 with the model to determine the roof condition risk score. For example, in one embodiment, the image processing module 135 is configured for pattern recognition to review the image of the roof for missing shingles, and is configured to output a binary output, e.g., a “1” if there are missing shingles and a “0” if there are no missing shingles. In one embodiment, the image processing module 135 is configured to determine various other roof characteristics from the image of the roof, e.g., roof slope, roof pitch, roof shape, type of roof, roof dimensions, roof direction, whether there is evidence of prior damage, e.g., hail damage, etc. The image processing module 135 provides indicators of each of the roof characteristics determined, and the indicators can be used by the roof condition risk scoring engine 130 with the model to determine the roof risk score 150.

In one embodiment, at least some of the roof characteristics determined by the image processing module 135 may be compared to the target roof input 110 and if any discrepancies are discovered between the roof characteristics determined by the image processing module 135 and the provided roof characteristics indicated by the target roof input 110, the roof condition risk scoring engine 130 outputs an indicator of the discrepancy. For example, if the provided roof covering material type differs from the roof covering material type determined from the image, if the provided roof slope differs from the roof slope determined from the image, if the provided roof pitch differs from the roof pitch determined from the image, if the provided roof direction differs from the roof direction determined from the image, or if the provided roof shape differs from the roof shape determined from the image, the system can output an indicator indicating the discrepancy.

With further reference to FIG. 2, in one embodiment, at block 230, the method 200 retrieves information regarding roof characteristics. For example, in one embodiment, the system 100 is configured to access information regarding roof age. Roof age may be determined based on, for example, permit data available through a permit data provider or a roof age information provider, e.g., BUILDERadius, Inc. (Asheville, N.C.) or BuildFax LLC (Asheville, N.C.). In another embodiment, information regarding roof age may be obtained from distributors and/or manufacturers of roofing materials, e.g., based on delivery and installation date of the roofing materials. In one embodiment, the system 100 obtains roof age information from combinations of the information sources listed herein to improve accuracy of the roof age determination. The system 100 can compare the roof age determined from information retrieved at block 230 to a roof age input into the system and can output an indicator if the determined roof age differs from the provided roof age.

At block 230, the method 200 accesses information regarding roof covering material type. Roof covering material type may be determined, for example, from roofing supply and installation sales information and delivery invoices from distributors and/or manufacturers of roofing supplies. In one embodiment, the system obtains roof covering material type based on information from distributors and/or manufacturers of roofing supplies and outputs an indicator if the determined roof covering material type differs from the provided roof covering material type.

With further reference to FIG. 2, at block 240, the method 200 retrieves weather information based on the location of the building. In one embodiment, the system 100 is configured to retrieve information regarding the average snowfall at the building location from a snowfall information provider, for example, the National Oceanic and Atmospheric Administration (“NOAA”). In one embodiment, the system is configured to retrieve information regarding ice (e.g., average ice) for the building (e.g., at the building location) from an ice information provider, for example, NOAA. In one embodiment, the system is configured to retrieve information regarding rainfall (e.g., average rainfall) for the building (e.g., at the building location) from a rainfall information provider, for example, NOAA. In one embodiment, the system is configured to retrieve information regarding humidity for the building from a humidity information provider, for example, MDA EarthSat Weather available from MDA Information Systems LLC. (“MDA”). In one embodiment, the system is configured to retrieve information regarding the heat index (e.g., average, minimum, maximum) for the building (e.g., at the building location) from a heat index information provider, for example, MDA. In one embodiment, the system is configured to retrieve information regarding the precipitation (e.g., average precipitation) for the building (e.g., at the building location) from a precipitation information provider, for example, MDA EarthSat. In one embodiment, the system is configured to retrieve information regarding the cloud cover (e.g., average cloud cover) for the building (e.g., at the building location) from a cloud cover information provider, for example, MDA EarthSat and/or NOAA. In one embodiment, the system is configured to retrieve information regarding the temperature (e.g., average, maximum, minimum, etc.) for the building (e.g., at the building location) from a temperature information provider, for example, MDA EarthSat. In one embodiment, the system is configured to retrieve information regarding the vegetation level for the building (e.g., at the building location) from a vegetation information provider, for example, CoreLogic, Inc. (Irvine, Calif.). In one embodiment, the system is configured to retrieve information regarding the elevation of the building (e.g., at the building location) from an elevation information provider, for example, CoreLogic. In other embodiments, the system may be configured to retrieve information regarding other general location weather data or other combinations of general location weather data.

In one embodiment, at block 240, the method 200 retrieves specific location weather data, e.g., historical data regarding specific weather events for a location, e.g., for the location of the building. In one embodiment, the system is configured to retrieve information regarding pre-existing damage to the roofing system (e.g., hail damage). For example, the system 100 may retrieve information regarding historical hail events that occurred at the building location since the current roof was installed, including, e.g., frequency of hailstorms, number of hailstorms, hailstone diameter, etc. Additionally, distance of the building location from the hail core of the hailstorms, for instance, using hail forensics information or a hail forensics map provided by a hail information provider, for example, Weather Fusion available from CoreLogic, may be retrieved and/or obtained. The system 100 can be configured to retrieve information regarding pre-existing wind damage. For example, the system may retrieve and/or obtain information regarding historical wind events that occurred at the building location since the current roof was installed, including, e.g., maximum wind speed, wind gust duration, etc., from a wind event information source such as, for example, Weather Fusion. The system 100 can be configured to retrieve information regarding other historic catastrophic events (e.g., tornados, hurricanes, thunderstorm events, etc.) at the building location since the current roof was installed from, for example NOAA or CoreLogic. In other embodiments, the system may be configured to retrieve information regarding other specific location weather data or other combinations of specific location weather data.

With further reference to FIG. 2, at block 250, the method 200 retrieves building characteristic data. For example, the system 100 can be configured to retrieve historic insurance policy information for the building, for example, from the insurance carrier that previously and/or currently insures the building. In one embodiment, the system 100 is configured to retrieve historic insurance claims information for the building, for example, from the insurance carrier that currently insures the building and/or insurance carriers that previously insured the building and/or, for example, CoreLogic. In one embodiment, the system 100 is configured to retrieve credit and/or financial information regarding the building and/or its current owner, for example, from a credit and/or financial information source such as, for example, CoreLogic. In one embodiment, the system 100 is configured to retrieve information regarding the builder of the building, e.g., builder name, from a builder information source such as, for example, CoreLogic. In one embodiment, the system 100 is configured to retrieve information regarding any warranty on the roof of the building, for example, from the manufacturer of the roofing material. In other embodiments, the system may be configured to retrieve information regarding other building characteristic data or other combinations of building characteristic data.

With further reference to FIG. 2, at block 260, based on the information received or retrieved in blocks 210, 230, 240, and 250, the information from processing the roof image in block 220, as well as the model with which the system 100 is configured to work, the method 200 generates a roof score, e.g., a roof condition risk score indicative of a probability of loss tied to roofing system replacement and/or reconstruction cost. The method 200 outputs the roof score and (optionally) a loss propensity associated with an estimated replacement/reconstruction cost for the roof at optional block 270. The method 200 may also output an estimate for the replacement/reconstruction cost for the roof or the roofing system. The roof score and loss propensity may be output by the system 100 by any suitable method or mechanism, e.g., via display, transmission of score over a network communication channel, a secure web portal, a secure Internet connection, etc.

The address-level roof condition risk prediction can be based on probabilistic modeling of pre-existing damage susceptibility associated with the roofing system replacement or reconstruction cost amount used for property insurance underwriting and pricing. The method 200 can use some or all of the data described with reference to data sources 352, 354, 356 in performing the probabilistic modeling to calculate a roof condition risk score or a loss propensity. In some embodiments, the roof condition risk score or loss propensity can account for future risk or impact caused by man-made events or other special events that could potentially impact the calculated condition of the roof.

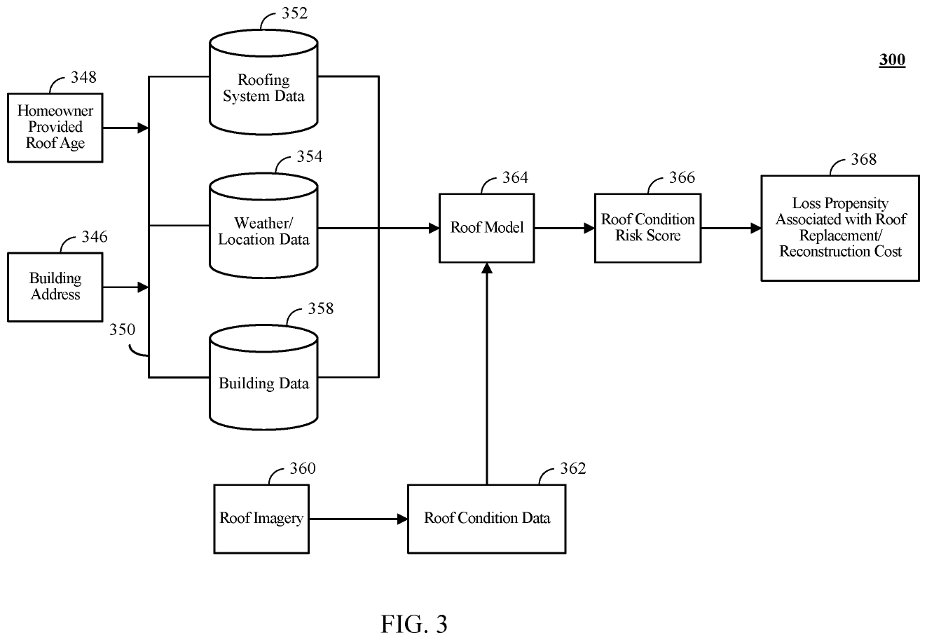

With reference to FIG. 3, a block diagram illustrating operation of an embodiment of a system 300 configured to transform inputs into an indicator of propensity of loss associated with roof replacement and/or reconstruction cost for a building is provided. In one embodiment, the transforming may include receiving inputs from a first source, e.g., an insurance carrier, an insurance underwriter, insurance agent, etc., regarding a building through an interface, communication link, etc. Based on the inputs received from the first source, the transforming may include establishing communication through a communication link with a second source and receiving from the second source additional information regarding the building, e.g., roofing system data, weather information, other building information, etc. And based on the information received from the second source and/or the information received from the first source, and a model, the transforming may include generating and/or outputting an indicator of propensity of loss associated with roof replacement and/or reconstruction cost for a building. In another embodiment, the transforming may include receiving information regarding a building from a first source and with the use of a model evaluating the information received from the first source to generate and output an indicator of propensity of loss associated with roof replacement and/or reconstruction cost of the building from the information regarding the building from the first source.

With further reference to FIG. 3, in one embodiment, a user, such as, e.g., an insurance agent, underwriter, etc., provides inputs illustrated as an address of a building 346 and a homeowner provided roof age 348 to be input into a roof condition risk scoring engine 350 (which can be the same as or similar to the roof condition risk scoring engine 130). The roof condition risk scoring engine 350 uses the inputs 346 and 348 to obtain and/or retrieve roofing system data 352, general location and specific location weather data 354, such as general location weather information and specific location weather information, other building data 358. The roofing system data 352, the weather/location data 354, and the building date 358 can be stored in one or more non-transitory data storage systems. The data storage systems may be accessible to the engine 350 via a wired or wireless network.

The roofing system data 352 can include, for example, roof age (e.g., submitted by a homeowner, obtained from building permit data, member listing services, or builder plans), roof dimensions, roof slope, roof aspect, roof pitch, roof direction, roof shape or roof type (e.g., gabled, cross-gabled, Mansard, flat, shed, hip, etc.), roof covering material type (e.g., steel, tin, tile, clay, slate, built-up tar and gravel, architectural shingles, wood shakes, asphalt shingles, etc.), roof building code, or roof installation (e.g., date).

The weather/location data 354 can include, for example, information on snowfall, rainfall, humidity, heat index, precipitation, temperature, or cloud cover. This data can include averages, minima, maxima, or ranges. The weather/location data 354 can include information on pre-existing hail damage, pre-existing wind damage, historic catastrophic events, historic tornado events, historic hurricane events, historic thunderstorm events, or historic lighting events. The weather/location data 354 can include information about a level of vegetation near the building.

The building data 358 can include, for example, historic insurance policy data for the building, historical insurance claims data for the building, building maintenance data, credit or financial data for the building owner, occupant, or insured, builder information, warranty coverage, or other pre-existing condition data.

The roof condition risk scoring engine 350 can also receive an image of the roof 360 and can analyze the image of the roof 360 with image processing techniques to provide an indicator of the condition of the roof 362. Examples of image processing techniques may include machine-learning techniques, such as supervised pattern recognition and classification, or other processing algorithms. The indicator of the roof condition data 362 and the inputs 346, 348, 352, 354, and 358 are input into a roof model 364. The roof model 364 can include a generalized linear model (e.g., with a binomial distribution link function), a logistical regression model, a support vector machine, a naïve Bayes model, a random forest analysis, a decision tree, supervised or unsupervised learning models, a neural network, a Bayesian network, a genetic algorithm, or other statistical or machine learning model.

The roof condition risk scoring engine 350 uses the roof model 364 and the inputs to produce a roof condition risk score 366. The roof condition score 366 can indicate the propensity of loss associated with roof replacement/reconstruction cost 368.

With reference to FIG. 4, a table illustrates example roof condition risk scores 470 and their respective probabilities of loss tied to roofing system replacement/reconstruction cost 472. In the illustrated embodiment, a roof condition risk score of 1 indicates a probability of loss of 0.0-0.2. A roof condition risk score of 2 indicates a probability of loss of 0.21-0.40. A roof condition risk score of 3 indicates a probability of loss of 0.41-0.60. A roof condition risk score of 4 indicates a probability of loss of 0.61-0.80. A roof condition risk score of 5 indicates a probability of loss of greater than 0.80. The numerical risk scores can be associated with a corresponding qualitative risk rating (e.g., a risk score of 1 indicates the roof condition is “very good”).

Embodiments of the system described herein may be used to provide a roof risk score without the need to have a person (e.g., an appraiser) be present at the location of the building to perform a physical roof inspection (e.g., the system generates the roof risk score without information from a physical roof inspection). This may be desirable, as there may be additional costs, time, etc., required to have someone perform a physical roof inspection. In another embodiment, a decision may be made whether or not to have a physical roof inspection performed based on the roof risk score, e.g., for buildings with scores in a certain range, a physical inspection may be performed, for example, before a roof insurance policy or rider is issued by an insurance company.

In one embodiment, the roof condition risk scoring engine and other roof risk score tools described herein may be integrated with other property insurance building valuation platforms to aid in, e.g., underwriting workflow in quantifying the probabilistic loss associated with reconstruction and/or replacement cost of a roofing system and may be used to aid in determining coverage associated with a property insurance policy, e.g., may be used to aid in determining the adjusted replacement and/or reconstruction cost of a roofing system that may be used to calculate the coverage associated with a property insurance policy.

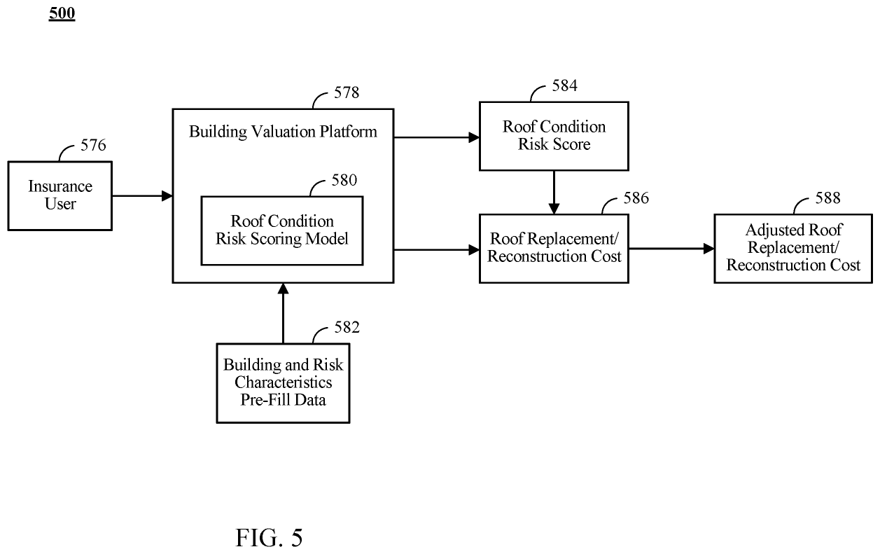

With reference to FIG. 5, an embodiment of a system 500 configured to be used by a user, e.g., an insurance user such as an insurer, an underwriter, etc., is illustrated. The user, illustrated as insurance user 576, provides input to a building valuation platform 578, such as, for example, MSB RCT Express or Commercial Express (available from Marshall & Swift/Boeck, LLC, Irvine, Calif.) or a policy administration system such as, for example, Guidewire PolicyCenter (available from Guidewire Software, Inc., Foster City, Calif.), Accenture Duck Creek (available from Accenture USA, NY), etc. The valuation platform 578 includes a tool implementing a roof condition risk scoring model 580, such as those described herein. Building and risk characteristics 582, such as those discussed herein (see e.g., data 352, 354, 358), may be provided to or retrieved by the valuation platform 578. In one embodiment, the building and risk characteristics 582 may be provided to the platform 578 in a pre-fill form, such as a document and/or file filled out in a prearranged format by the user with information regarding the building and risk characteristics 582. The platform 578 can be configured to generate and output a roof condition risk score 584 and a roofing system replacement and/or reconstruction cost 586 based on the model 580, the input provided by the insurance user 576, and the building and risk characteristics data 582. The roofing system replacement and/or reconstruction cost 586 may then be adjusted based on probability of loss value generated from the model to produce an adjusted replacement and/or reconstruction cost for the roofing system 588 which may be output.

In one embodiment, a thermal image of a building may also be obtained by various embodiments of systems and tools described herein. The thermal image may be used by the systems and tools to determine condition of roofs based on leaks that may be present, which can be an indicator for future insurance claims. The thermal imaging data may be used by the roof condition risk scoring engine 130, 350 (with the other data described herein) to generate a roof risk condition score.

In another embodiment, the roof condition risk scoring engine 130, 350 may obtain information regarding the hailstone diameter that fell on a particular building and this information may be used by the roof condition risk scoring engine to generate, along with the other inputs, a roof risk condition score. In another embodiment, the roof condition risk scoring engine 130, 350 may obtain information regarding the number of historical hail events experienced in a particular building location, maximum wind speed, and the dates of historical events. The roof condition risk scoring engine may use this information, along with other inputs, to generate a roof risk condition score.

In another embodiment, the roof condition risk scoring engine 130, 350 may also be configured to retrieve and/or obtain information regarding whether a prior claim was filed based on historical weather data to determine whether roof damage from a previous weather event was fixed or whether the roof remains damaged. This information may be used in the roof risk condition score generation.

In one embodiment, a network communication link or channel as described herein may be an Internet link, a secure communication connection, e-mail, or any other suitable communication link or interface allowing communication between the roof condition risk scoring engine and an information provider.

Embodiments described herein may make information regarding buildings available at the time of underwriting or at times when portfolios of buildings are being analyzed.

In one embodiment, when a user, such as an underwriter or an insurance provider, is developing pricing options for different options for insuring a building, a roof condition risk scoring engine such as those described herein may be used to determine roof condition risk and to determine the adjusted roofing system reconstruction/replacement costs for insurance pricing (e.g., premium options, insurance policy length options, deductible options, product options, etc.).

In another embodiment, systems and tools with models such as those described herein may be used to determine a value of a roof of a building as it depreciates over time based on the models.

In one embodiment, systems and tools such as those described herein are configured to receive input from a user and to determine if information is missing from the input. In one embodiment, a tool is configured to supply information missing from the input based on the model and other information present in the input. In one embodiment, a tool is configured to indicate to a user if information is missing from the input.

In one embodiment, systems and tools such as those described herein are configured to be used by consumers interested in information regarding a building for possible purchase of the building. In other embodiments, systems and tools such as those described herein are configured to be used by underwriters and/or insurance providers interested in information regarding a building for possibly providing insurance for the building.

In one embodiment, the roof condition risk indicators output by a system are color coded by the system to indicate visually the level of risk determined by the system. In one embodiment, a system is configured to receive a portfolio (e.g., inputs regarding a plurality of buildings, for example, in a file provided to the system through the interface) and to analyze the inputs provided for each of the buildings in the portfolio. The system is configured to generate and output a file with a roof risk indicator for each of the buildings in the portfolio, with the roof risk indicators color coded to visually indicate the risk determined for each of the buildings.

In some embodiments, systems and tools such as those described herein are configured to generate an alert when a threshold is reached. For example, an alert may be generated when the roof risk condition score reaches a threshold, or is within a range. Other suitable thresholds or combination of thresholds may also be used. For example, in a real-time evaluation, the alert may be color coded, or may be a pop-up or a sound, etc., to notify a user that the evaluation indicates high risk of roof condition issues.

For purposes of this disclosure, reconstruction cost can refer to total cost (e.g., projected total cost, estimated total cost, etc.) to provide and install an identical roof for a building, taking into account additional costs due to difficulties with installing the roof in the location due to other structures surrounding the location, increased difficulty and cost in obtaining identical materials, labor cost, equipment cost, and various other factors.

### CONCLUSION

Further modifications and alternative embodiments of various aspects of described herein will be apparent to those skilled in the art in view of this description. Accordingly, this description is to be construed as illustrative. The construction and arrangements, shown in the various example embodiments, are illustrative only. Although only a few embodiments have been described in detail in this disclosure, many modifications are possible without materially departing from the novel teachings and advantages of the subject matter described herein. The position of elements may be reversed or otherwise varied, and the nature or number of discrete elements or positions may be altered or varied. Other substitutions, modifications, changes and omissions may also be made in the design, operating conditions and arrangement of the various example embodiments without departing from the scope of the present disclosure. No single feature, or group of features, is necessary or indispensable to each embodiment.

The order or sequence of any process, logical algorithm, or method steps may be varied or re-sequenced according to alternative embodiments. Other substitutions, modifications, combinations, changes and omissions may also be made in the design, operating conditions and arrangement of the various example embodiments without departing from the scope of the present disclosure. While the current application recites particular combinations of features, various embodiments described herein relate to any combination of any of the features described herein whether or not such combination is currently claimed, and any such combination of features may be claimed in this or future applications. Any of the features, elements, or components of any of the example embodiments discussed herein may be used alone or in combination with any of the features, elements, or components of any of the other embodiments discussed herein.

In various embodiments, the systems, engines, and/or methods described herein may be implemented in software. In another embodiment, the systems, engines, and/or methods described herein may be implemented in a combination of computer hardware and software. In various embodiments, systems implementing the tools discussed herein include one or more processing components, one or more computer memory components, and one or more communication components. In various embodiments, the processing components may include a general purpose processor programmed with specific and particular computer instructions to carry out the disclosed functions and methods, an application specific processor (ASIC), a circuit containing one or more processing components, a group of distributed processing components, a group of distributed computers configured for processing, etc., configured to provide the functionality of the evaluation tools discussed herein. In various embodiments, memory components may include one or more devices for storing data and/or computer code for completing and/or facilitating the various processes described in the present disclosure, and may include database components, object code components, script components, and/or any other type of information structure for supporting the various activities described in the present disclosure. In various embodiments, the communication components may include hardware and software for communicating data for the system and methods discussed herein. For example, communication components may include, wires, jacks, interfaces, wireless communications hardware etc., for receiving and transmitting information as discussed herein. In various specific embodiments, the tools and/or systems and/or methods described herein, may be embodied in non-transitory, computer readable media, including instructions (e.g., computer coded) for providing the various functions and performing the various steps discussed herein. In various embodiments, the computer code may include object code, program code, compiled code, script code, executable code, instructions, programmed instructions, non-transitory programmed instructions, or any combination thereof. In other embodiments, evaluation tools described herein may be implemented by any other suitable method or mechanism.

Further, certain implementations of the functionality of the present disclosure are sufficiently mathematically, computationally, or technically complex that application-specific hardware, circuitry or one or more physical computing devices (utilizing appropriate executable instructions) may be necessary to perform the functionality, for example, due to the volume or complexity of the calculations involved or to provide results substantially in real-time.

Any processes, blocks, states, steps, or functionalities in flow diagrams described herein and/or depicted in the attached figures should be understood as potentially representing code modules, segments, or portions of code which include one or more executable instructions for implementing specific functions (e.g., logical or arithmetical) or steps in the process. The various processes, blocks, states, steps, or functionalities can be combined, rearranged, added to, deleted from, modified, or otherwise changed from the illustrative examples provided herein. In some embodiments, additional or different computing systems or code modules may perform some or all of the functionalities described herein. The methods and processes described herein are also not limited to any particular sequence, and the blocks, steps, or states relating thereto can be performed in other sequences that are appropriate, for example, in serial, in parallel, or in some other manner. Tasks or events may be added to or removed from the disclosed example embodiments. Moreover, the separation of various system components in the implementations described herein is for illustrative purposes and should not be understood as requiring such separation in all implementations. It should be understood that the described program components, methods, and systems can generally be integrated together in a single computer product or packaged into multiple computer products. Code modules or any type of data may be stored on any type of non-transitory computer-readable medium or memory, such as physical computer storage including hard drives, solid state memory, random access memory (RAM), read only memory (ROM), optical disc, volatile or non-volatile storage, combinations of the same and/or the like. The methods and modules (or data) may also be transmitted as generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). The results of the disclosed processes or process steps may be stored, persistently or otherwise, in any type of non-transitory, tangible computer storage or may be communicated via a computer-readable transmission medium.

The processes, methods, and systems may be implemented in a network (or distributed) computing environment. Network environments include enterprise-wide computer networks, intranets, local area networks (LAN), wide area networks (WAN), personal area networks (PAN), cloud computing networks, crowd-sourced computing networks, the Internet, and the World Wide Web. The network may be a wired or a wireless network or any other type of communication network.

The various elements, features and processes described herein may be used independently of one another, or may be combined in various ways. All possible combinations and subcombinations are intended to fall within the scope of this disclosure. Further, nothing in the foregoing description is intended to imply that any particular feature, element, component, characteristic, step, module, method, process, task, or block is necessary or indispensable. The example systems and components described herein may be configured differently than described. For example, elements or components may be added to, removed from, or rearranged compared to the disclosed examples.

As used herein any reference to “one embodiment” or “some embodiments” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. In addition, the articles “a,” “an,” and “the” as used in this application and the claims are to be construed to mean “one or more” or “at least one” unless specified otherwise.

As used herein, the terms “comprises,” “comprising,” “includes,” “including,” “has,” “having” or any other variation thereof, are synonymous and open-ended terms and intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y and at least one of Z to each be present.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A system comprising:
physical data storage configured to store data associated with roofing systems associated with a plurality of real estate properties; and
a computer system comprising computer hardware, the computer system in communication with the physical data storage, the computer system programmed to:
receive identification information associated with a property, the identification information comprising a location of the property;
receive a roofing characteristic associated with a roofing system associated with the property, the roofing system comprising a roof of a building on the property;
receive a weather characteristic associated with the location of the property;
receive an image of the roof of the building on the property;
analyze the image using machine learning to determine a roof image characteristic that indicates whether the roof of the building includes any missing shingles;
determine a risk of roof damage based at least in part on applying a roof condition machine learning model to the identification information, the roofing characteristic, the weather characteristic, and the roof image characteristic; and
output an indicator of a discrepancy between the determined roof image characteristic and the received roofing characteristic.

2. The system of claim 1, wherein the identification information comprises information related to one or more of an elevation of the building, a builder of the roofing system or building, building code compliance, maintenance of the building or the roofing system, warranty coverage for the building or the roofing system, or financial data regarding the building or an owner or occupant of the building.

3. The system of claim 1, wherein the roof characteristic comprises one or more of a roof age, a roof dimension, a roof slope, a roof aspect, a roof pitch, a roof direction, a roof shape, a roof type, a roof covering material type, a roof building code, or a roof installation.

4. The system of claim 1, wherein the weather characteristic comprises information related to one or more of snowfall, rainfall, humidity, heat index, precipitation, temperature, cloud cover, hail, catastrophe events, tornado events, hurricane events, thunderstorm events, or lightning events.

5. The system of claim 1, wherein the weather characteristic comprises information on pre-existing damage to the roofing system.

6. The system of claim 5, wherein the pre-existing damage comprises pre-existing damage from a historical weather event.

7. The system of claim 5, wherein the computer system is programmed to determine the risk of roof damage without information from a physical inspection of the roofing system.

8. The system of claim 1, wherein the weather characteristic comprises information related to one or more of hail events, hail size, hail duration, hail direction, a distance of the location of the property from a hail core of a hailstorm, a date of a last hail event, a date of a last severe hail event, or a number or frequency of hail events.

9. The system of claim 1, wherein the roof image characteristic comprises at least one of a slope of the roof, a pitch of the roof, a dimension of the roof, a shape of the roof, or evidence of prior damage to the roof.

10. The system of claim 1, wherein the roof condition machine learning model is one or more of a logistic regression model, a binomial distribution model, a generalized linear model, a support vector machine, a naïve Bayes model, or a random forest model.

11. The system of claim 1, wherein the computer system is further programmed to calculate a probability of loss associated with an estimate for a replacement cost or a reconstruction cost for the roofing system.

12. The system of claim 11, wherein the computer system is further programmed to determine the replacement cost or the reconstruction cost for the roofing system.

13. The system of claim 1, wherein the computer system is further programmed to receive insurance claims information relating to whether a previous insurance claim was made for the roofing system, and to determine the risk of roof damage based at least in part on the received insurance claims information.

14. A computer-implemented method comprising:
receiving identification information associated with a property, the identification information comprising a location of the property;
receiving a roofing characteristic associated with a roofing system associated with the property, the roofing system comprising a roof of a building on the property;
receiving a weather characteristic associated with the location of the property;
receiving an image of the roof of the building on the property;
analyzing the image using machine learning to determine a roof image characteristic that indicates whether the roof of the building includes any missing shingles;
applying a roof condition machine learning model to the roofing characteristic, the weather characteristic, and the roof image characteristic to determine a risk of roof damage; and
output an indicator of a discrepancy between the determined roof image characteristic and the received roofing characteristic.

15. The computer-implemented method of claim 14, wherein the identification information comprises information related to one or more of an elevation of the building, a builder of the roofing system or building, building code compliance, maintenance of the building or the roofing system, warranty coverage for the building or the roofing system, or financial data regarding the building or an owner or occupant of the building.

16. The computer-implemented method of claim 14, wherein the roof characteristic comprises one or more of a roof age, a roof dimension, a roof slope, a roof aspect, a roof pitch, a roof direction, a roof shape, a roof type, a roof covering material type, a roof building code, or a roof installation.

17. The computer-implemented method of claim 14, wherein the weather characteristic comprises information related to one or more of snowfall, rainfall, humidity, heat index, precipitation, temperature, cloud cover, hail, catastrophe events, tornado events, hurricane events, thunderstorm events, or lightning events.

18. The computer-implemented method of claim 14, wherein the weather characteristic comprises information on pre-existing damage to the roofing system caused by a historical weather event.

19. The computer-implemented method of claim 18, wherein the risk of roof damage is determined generated without information from a physical inspection of the roofing system.

20. The computer-implemented method of claim 14, wherein the weather characteristic comprises information related to one or more of hail events, hail size, hail duration, hail direction, a distance of the location of the property from a hail core of a hailstorm, a date of a last hail event, a date of a last severe hail event, or a number or frequency of hail events.

21. The computer-implemented method of claim 14, wherein the roof condition machine learning model is one or more of a logistic regression model, a binomial distribution model, a generalized linear model, a support vector machine, a naïve Bayes model, or a random forest model.

22. The computer-implemented method of claim 14, further comprising calculating a probability of loss associated with an estimate for a replacement cost or a reconstruction cost for the roofing system.

23. The computer-implemented method of claim 14, further comprising receiving insurance claims information relating to whether a previous insurance claim was made for the roofing system, and wherein the determined risk of roof damage is based at least in part on the received insurance claims information.
